(19) United States
(12) Patent Application Publication
(10) Pub. No.: US 2002/0070465 A1
(43) Pub. Date: Jun. 13, 2002

(54) Water conservation system for humidifiers

(76) Inventors: Gerald Stephen Harvel, East Dundee, IL (US); William Anthony Wangler, Elmhurst, IL (US); Ralph Lipsey Barnett, Wilmette, IL (US)

Correspondence Address: Mark E. Fejer, Pauley Petersen Kinne & Fejer, Suite 365, 2800 West Higgins Road, Hoffman Estates, IL, 60195, US

(21) Appl. No.: 09/732,075

(22) Filed: Dec. 7, 2000

(51) Int. Cl. B01F 3/04

(52) U.S. Cl. 261/36.1; 261/70; 261/103

(57) ABSTRACT

A humidification system having a humidifier housing having a supply water inlet and an excess water outlet, which excess water outlet is in fluid communication with a water reservoir vessel. A pump is provided by way of which water in the water reservoir vessel is circulated to the supply water inlet of the humidifier housing.

### BACKGROUND OF THE INVENTION

1. Field of the Invention

This invention relates to humidification systems which are of the duct-mounted type, which systems are normally used in ducted forced air heating or air handling systems. More particularly, this invention relates to a humidification system of the duct-mounted type which substantially eliminates the discharge of excess water down the drain.

2. Description of Prior Art

Humidifiers are commonly used in homes and other types of buildings during the winter to supplement the drop in humidity due to heating systems. Hot air systems tend to lower the humidity more than other systems due to the evaporation of water particles during heating. This, and the fact that hot air furnaces are the easiest to fit with humidifiers, has resulted in a plethora of such devices. Most such devices for hot air systems use a “wetted element”. The stationary type of element, such as a sponge, is maintained wet through the use of a constant flow of water. The rotating type of element comprises a wheel or drum covered by a pad which continually rotates in water. The humidifier is connected to the building water supply, eliminating the need for manual refills.

Many humidification systems discharge excess water down the drain. These systems are typically duct-mounted and normally use ducted forced air heating or air handling systems. The amount of water discharged down the drain in some cases may be as high as one-half gallon per hour. This calculates to about 1,080 gallons per household per humidification season in the midwest region of the United States.

Humidification systems employing means for conserving water, including the recovery and recirculation of waste water, are known. U.S. Pat. No. 4,257,389 to Texidor et al. teaches a humidifier for a forced air furnace in which water flowing in a coiled tube disposed in the exhaust path for waste gas from a combustion chamber is vaporized by heat transfer from the waste gas and transferred in admixture with unvaporized water into a container in the warm air duct of the furnace. The steam humidifies the air while the unvaporized water is separated and returned to the exhaust path of the combustion chamber where it, in turn, is vaporized and vented to the atmosphere.

U.S. Pat. No. 4,410,136 to Oliver, Jr. teaches a furnace economizer-humidifier comprising a flue having a conduit spaced from and concentric with the flue. Means are provided for forcing air from the upper part of the conduit downwardly through the annulus formed between the conduit and the flue in a direction opposite to the normal flow of the gases in the flue. Means are also provided for applying moisture to the outer surface of the upper part of the flue within the conduit and above the means for forcing air into the conduit. The moisture which is sprayed onto the outer surface of the flue creates the heat transfer as it evaporates into the airstream, thereby providing the humidity which is normally required. Any condensate which remains after the air passes downwardly through the annulus may be removed by means of a condensate line. Such water may be reused if desired by pumping it back to the water supply line.

And, U.S. Pat. No. 5,570,680 to Payne teaches an apparatus and process for condensing hot air humidification using aqueous condensate from flue gases generated by the thermal exchanger in a furnace as the primary aqueous input to the evaporator of a humidifier. In accordance with one embodiment, a drain line from the humidifier is provided for recycling excess water.

However, none of the prior art references address the problem of excess water discharge from duct-mounted humidification systems.

### SUMMARY OF THE INVENTION

Accordingly, it is one object of this invention to provide a humidification system of the duct-mounted type which substantially eliminates the discharge of excess water into a drain.

This and other objects of this invention are addressed by a humidification system comprising a humidifier housing having a housing water inlet and an excess water outlet, a water reservoir vessel having an excess water inlet in fluid communication with the excess water outlet of the humidifier housing and a water supply inlet in fluid communication with a water supply, and circulation means for circulating water from the water reservoir vessel into the humidifier housing.

### BRIEF DESCRIPTION OF THE DRAWINGS

These and other objects and features of this invention will be better understood from the following detailed description taken in conjunction with the drawings wherein:

FIG. 1 is a diagram of a conventional duct-mounted type humidifier system; and

FIG. 2 is a diagram of a humidification system in accordance with one embodiment of this invention.

### DETAILED DESCRIPTION OF THE PRESENTLY PREFERRED EMBODIMENTS

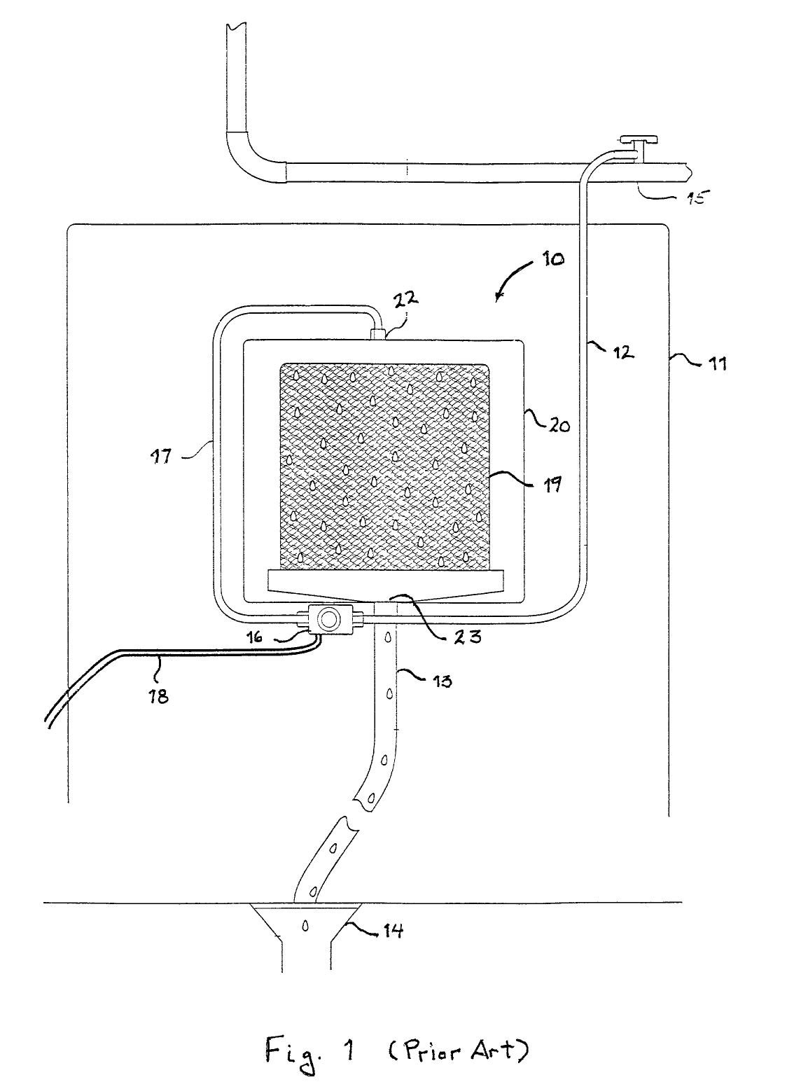

FIG. 1 shows a conventional humidifier system currently in use and the means for providing humidification to the warm air produced by a residential or building furnace. Humidification system 10 comprises humidifier housing 20 having a water supply inlet 22 and an excess water outlet 23 in fluid communication with excess water drain line 13 which drains excess water into floor drain 14. The humidifier system 10 is typically attached to a wall 11 of the furnace by conventional means whereby the interior space of humidifier housing 20 is in fluid communication with the warm air supply from the furnace. Water is supplied to humidifier system 10 through supply water line 12 which is connected between water supply 15 and the input side of water supply solenoid valve 16. Water supply solenoid valve 16 is operatively connected by means of solenoid valve control line 18 to the furnace control system (not shown) which controls the opening and closing of water supply solenoid valve 16. The output side of water supply solenoid valve 16 is connected to humidifier supply line 17 which provides fluid communication between water supply solenoid valve 16 and water supply inlet 22 of humidifier housing 20. Water introduced into humidifier housing 20 through water supply inlet 22 is distributed onto evaporator pad 19 by known means. As will be apparent from FIG. 1, any excess water introduced into humidifier housing 20 in a conventional system will be discarded through excess water drain line 13 into floor drain 14.

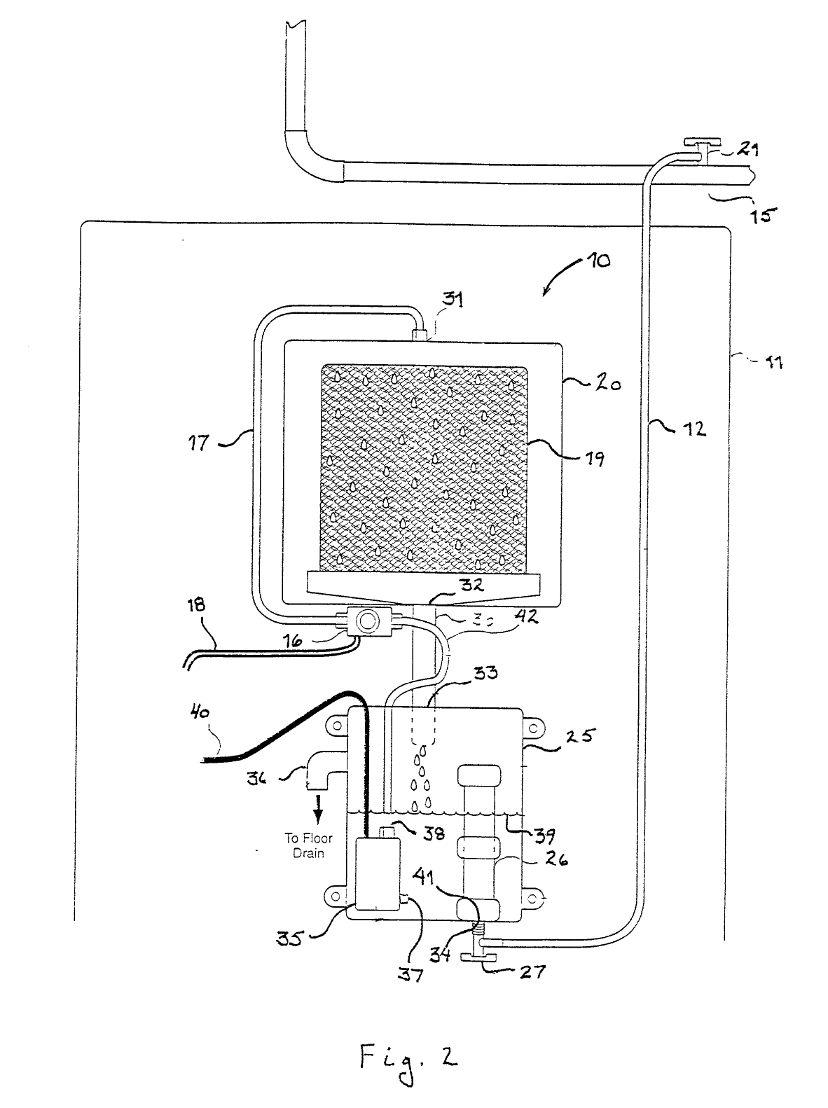

The humidifier system of this invention, shown in FIG. 2, comprises a humidifier housing 20 having housing water inlet 31 and excess water outlet 32, in which housing evaporator pad 19 is located. As in conventional systems, water supply solenoid valve 16 having a water inlet side and a water outlet side is used as a means for controlling the flow of water through humidifier supply line 17 and housing water inlet 31 into humidifier housing 20.

In accordance with the embodiment shown in FIG. 2, the humidification system of this invention comprises water reservoir vessel 25 having excess water inlet 33 which is in fluid communication with excess water outlet 32 of humidifier housing 20 by means of excess water drain line 30. Water reservoir vessel 25 has a water supply inlet 34 which is in fluid communication with water supply 15 of either cold, warm or hot water. Water is supplied to water reservoir vessel 25 through supply water line 12 which connects water supply 15 to water supply inlet 34 by way of water supply valve 21 and reservoir water supply valve 27. Disposed within water reservoir vessel 25 is float valve 26 having float valve water inlet 41 in fluid communication with water supply inlet 34 to water reservoir vessel 25. Float valve 26 is used to maintain water level 39 within water reservoir vessel 25 at a desired level. Thus, in addition to supply water, as previously indicated, excess water from humidifier housing 20 is also conveyed through excess water drain line 30 into water reservoir vessel 25.

Disposed within water reservoir vessel 25 is pump 35 which has a reservoir water inlet 37 and a pump water outlet 38. In accordance with one embodiment of this invention, pump 35 is submersible within the water located in water reservoir vessel 25. It will be apparent to those skilled in the art that pump 35 may be disposed outside of water reservoir vessel 25 rather than within water reservoir vessel 25 as show in FIG. 2. Pump water outlet 38 is in fluid communication with pump water supply line 42 which is connected at one end to the water input side of water supply solenoid valve 16, thereby providing fluid communication between pump 35 and water supply solenoid valve 16. Power is provided by means of power supply line 40 to pump 35. As in conventional systems, the water output side of water supply solenoid valve 16 is connected to one end of humidifier supply line 17 through which water is supplied through housing water inlet 31 into humidifier housing 20. Water supply solenoid valve 16 is operably connected to the furnace control system by means of control line 18 as in conventional systems. Water reservoir vessel 25 further comprises emergency overflow line 36 which, in turn, is in fluid communication with a floor drain.

Thus, in accordance with the humidification system of this invention, excess water from humidifier housing 20 is drained directly into water reservoir vessel 25, where it mixes with supply water in water reservoir vessel 25, and is returned by means of submersible pump 35, pump water supply line 42, water supply solenoid valve 16, humidifier supply line 17, and housing water inlet 31 into humidifier housing 20, thereby eliminating the loss of excess water as in conventional systems.

It will be apparent to those skilled in the art that other embodiments of this invention whereby excess water is collected and recirculated back to the humidifier are feasible, and such embodiments are deemed to be within the scope of this invention. For example, float valve 26 may be an autofill float valve as discussed hereinabove, or it may be a simple float device which is operatively connected to reservoir water supply valve 27. In addition, other means for controlling the water level within water reservoir housing 25 which are operatively connected to reservoir water supply valve 27 may be envisioned. For example, pump 35 may be used as the controlling element for water flow rate into the humidifier housing 20, thereby eliminating the need for solenoid valve 16. In accordance with one embodiment of this invention, a disposable liner is provided for the inside of water reservoir vessel 25.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A humidification system comprising:
a humidifier housing having a housing water inlet and an excess water outlet;
a water reservoir vessel having an excess water inlet in fluid communication with said excess water outlet and a water supply inlet in fluid communication with a water supply; and
circulation means for circulating water from said water reservoir vessel into said humidifier housing.

2. A humidification system in accordance with claim 1, wherein said circulation means comprises a pump having a reservoir water inlet and a pumped water outlet disposed in said water reservoir vessel, said pumped water outlet being in fluid communication with said housing water inlet.

3. A humidification system in accordance with claim 1 further comprising level control means for maintaining a water level in said water reservoir vessel.

4. A humidification system in accordance with claim 3, wherein said level control means comprises a float valve disposed within said water reservoir vessel and having a valve water inlet in fluid communication with said water supply inlet and a valve water outlet in fluid communication with an interior of said water reservoir vessel.

5. A humidification system in accordance with claim 2, wherein said pump is a submersible pump submerged in said water in said water reservoir vessel.

6. In a humidification system comprising a humidifier housing having a supply water inlet and an excess water outlet, the improvement comprising:
a water reservoir vessel having an excess water inlet in fluid communication with said excess water outlet and a water inlet in fluid communication with a water supply;
water level control means for maintaining a water level in said water reservoir vessel; and
water circulation means for circulating water from said water reservoir vessel into said humidifier housing.

7. A humidification system in accordance with claim 6, wherein said water circulation means comprises a pump having a reservoir water inlet in fluid communication with said water in said water reservoir vessel and a pumped water outlet in fluid communication with said housing water inlet.

8. A humidification system in accordance with claim 6, wherein said water level control means comprises a float valve disposed within said water reservoir vessel operatively connected to a supply water valve, said supply water valve having a supply water outlet in fluid communication with said water inlet of said water reservoir housing.

9. A humidification system in accordance with claim 6, wherein said water circulation means comprises control means for controlling a flow rate of said water into said water reservoir vessel.
